(19) United States
(12) Patent Application Publication
(10) Pub. No.: US 2008/0070654 A1
(43) Pub. Date: Mar. 20, 2008

(54) Game Device

(75) Inventors: Koji Okamoto, Kanagawa (JP); Hachitaro Sato, Tokyo (JP)

Correspondence Address: RANKIN, HILL & CLARK LLP, 38210 Glenn Avenue, WILLOUGHBY, OH, 44094-7808, US

(73) Assignee: KONAMI DIGITAL ENTERTAINMENT CO., LTD., Tokyo (JP)

(21) Appl. No.: 11/570,297

(22) PCT Filed: Jun. 13, 2005
(86) PCT No.: PCT/JP05/10813

§ 371 Date: Dec. 8, 2006

(30) Foreign Application Priority Data
Jun. 11, 2004 (JP) 2004-174863

(51) Int. Cl. A63F 13/04

(52) U.S. Cl. 463/3; 463/36; 463/5

(57) ABSTRACT

A game apparatus is provided with which a game player hits a movable object displayed on a screen at one or more targets displayed on the screen. The motion of the movable object moving on the screen is changed based on an input from the input device operated by the player in order to hit the movable object at a target displayed on the screen. The operation timing determination means 49 determines operation timing at which the input device is operated by the player. The moving-direction change means 51 changes the moving direction of the movable object according to a change command upon receipt of the change command while moving the movable object. The operation timing determination means outputs the change command to the moving-direction change means based on the determined operation timing.

### TECHNICAL FIELD

The present invention relates to a game apparatus with which a player hits a movable object at a target displayed on a screen by changing a moving direction of the movable object displayed on the screen, a method of deciding a moving-direction of the movable object such as a ball displayed on the screen, and a program for game apparatus.

### RELATED ART

In the past, a baseball game apparatus, with which a player performs batting with an actual ball to hit the ball at a target in order to score points, has been disclosed in Japanese Patent Publication No. 09-47534, Japanese Patent Publication No. 2001-62018, and a soccer game apparatus, with which a player kicks an actual ball to compete in hitting at a target, has been disclosed in Japanese Patent Publication No. 2000-210402 and No. 2000-350800.
Patent Document 1: Japanese Patent Publication No. 09-47534
Patent Document 2: Japanese Patent Publication No. 2001-62018
Patent Document 3: Japanese Patent Publication No. 2000-210402
Patent Document 4: Japanese Patent Publication No. 2000-350800

### DISCLOSURE OF THE INVENTION

### Problem to be Solve by the Invention

As far as the applicant knows, there has been no game apparatus for what is called a TV game in which images are displayed on the screen, like the target hitting games described above.

An object of the present invention is to provide a game apparatus for a game in which one or more targets displayed on a screen are hit with a movable object such as a ball displayed on the screen.

Another object of the present invention is to provide an unprecedented game apparatus for a target-hitting game which can increase interest the game player's interest in the game.

A further object of the present invention is to provide an unprecedented game apparatus for a target-hitting game which can increase the game player's interest in the game much more by stimulating the player to eagerly conquer the game.

Still another object of the present invention is to provide a moving-direction determination method for a movable object and a program for a game apparatus, which are suitable for use with an unprecedented game apparatus for a target-hitting game.

### Means to Solve the Problem

The present invention is directed to a game apparatus for playing a game that allows a player to operate an input device in such a manner that a moving direction of a movable object, which is displayed by image display means on a screen, is changed based on an input from the input device operated by the player in order to hit the movable object at a target displayed on the screen. In the present invention, the moving direction of the movable object is changed based on operation timing at which the input device is operated. Herein, one example of the operation timing is timing at which a switch is pushed when the input device is a game controller equipped with the switch as an input operation portion. When the input device is constructed to detect that the player has actually swung a game tool that imitates a bat or a golf club and generate an input signal, timing at which the game tool has been swung is the operation timing.

In the game apparatus of the present invention, a motion (moving or flying) direction of the movable object which is moving is changed based on the operation timing of the input device in order to hit the movable object at a target. Accordingly, the player can change the moving direction of the movable object, feeling as if he/she actually hits or kicks a flying or moving ball (movable object) to move it to an aimed position. The game apparatus of the present invention makes the player feel as if he/she actually hits or kicks the ball (movable object) at the target. Therefore, the game apparatus of the present invention can increase the player's interest in the game and is an unprecedented game apparatus for a target-hitting game.

More specifically, the game apparatus of the present invention comprises a target display means for displaying on the screen one or more targets to be hit with the movable object, operation timing determination means for determining operation timing at which the input device is operated by the player, and moving-direction change means for moving the movable object and changing the moving direction of the movable object according to a change command upon receipt of the change command while moving the movable object. The operation timing determination means outputs the change command to the moving-direction change means based on the determined operation timing. It is preferred that the game apparatus further comprises hit determination means for determining whether or not the movable object has hit at the one or more targets. In this case, the target display means may have a function of displaying the one or more targets on the screen in accordance with one display mode selected from a plurality of the display modes having a different mode change condition and a different display composition, and a function of selecting another display mode from the plurality of display modes when it is determined by the hit determination means that the mode change condition of the selected display mode has been satisfied.

How the target display means selects one display mode from the plurality of display modes is arbitrary. For example, the display mode may be selected from the plurality of display modes in a predetermined order, or at random, or in accordance with a predetermined select condition.

Here, the mode change condition means a necessary condition to change the display mode used in a game by selecting one display mode from the plurality of display modes. For example, it may be the number of times that the movable object has hit at the targets, the points scored by hitting the movable object at the targets, and hitting the movable object at one or more particular targets. The display composition of the display modes includes diversified display patterns formed by combination of the number of targets, target shapes, points indicated on the face of each of the targets, target locations, and whether or not the targets are moving, which are displayed on the screen until one mode change condition is satisfied. Therefore, when the display mode is changed, the points indicated on the targets, target locations and others are also changed. How to define a display composition of one display mode is arbitrary, and is not limited to the display compositions of embodiments of the present invention described below. How interesting the game is depends upon what display compositions are prepared for the display modes. Therefore, if a plurality of display modes are prepared, the player's interest in the game will further be increased.

It is also preferred that the display compositions of the plurality of display modes are defined so that the number of the one or more targets to be displayed on the screen may decrease as the display mode is selected later. In this manner, the player can increase a pleasure of conquering the game since the probability of hitting the movable object at the target goes down.

It is also preferred that the mode change conditions of the plurality of display modes are defined to become more complex as the display mode is selected later. In this manner, even if the number of targets and the state of the targets are substantially the same, it may be required, in order to change the display mode, to satisfy such difficult or complex conditions that the player has to hit the movable object at more targets, or has to hit the movable object only at a specific target within a limited time. This stimulates the player to eagerly conquer the game, thereby further increasing the player's interest in the game.

At least one of the plurality of display modes may be defined to move the one or more targets. When the targets are moving, it is required to predict a destination to which the targets are moving and to change the moving direction of the movable object. Therefore, the game becomes still more difficult, thereby further stimulating the player to more eagerly conquer the game.

As mentioned above, the construction of the input device is arbitrary. The input device may include a game tool to be operated by the player in a three dimensional space, and motion signal generation means for detecting a motion of the game tool in the three dimensional space and outputting an motion signal according to the detected motion. It is preferred in this case that the operation timing determination means determines the operation timing based on timing at which the motion signal is generated. If the game tool is included in the component elements of the input device, the player actually shakes or swings the game tool during the play, thereby enjoying the game with more realistic sensation. Furthermore, since the player can physically feel the operation timing, the player can enjoy the game more powerfully as if he/she actually participates in a real fight, compared with the game in which the game tool is not used.

The game tool may be a simulated-sports game tool that imitates sports equipment such as a bat and a racket, or a wearable game tool that is a substitution for a shoe for the player's foot and for a hand of the player. As a matter of course, other game tools may be prepared.

The motion signal generation means may arbitrarily be constructed and disposed in an arbitrary place. For example, the input device may be received in a body of the game apparatus, and may have on its surface a light-reflecting material that actively reflects light. In this case, the motion signal generation means includes a light-emitting element that emits out light in the three dimensional space in which the game tool is operated and a light-receiving element that receives reflected light that has been emitted from the light-emitting element and reflected on the light reflecting material. In this case, the motion signal is generated based on an output from the light-receiving element. With this arrangement, the operation timing of the game tool (operation timing of the input device) is detectable using a light-receiving element and a light-emitting element that are commercially available at a low price. Therefore, the price of the game apparatus can be significantly reduced compared with an existing game apparatus for a similar virtual or simulation game to the present invention.

The present invention is also directed to a moving-direction determination method for a movable object in a game apparatus for playing a game in which a moving direction of the movable object displayed on a screen is determined to hit the movable object at one or more targets displayed on the screen. Even when the present invention is understood as such a method, there is no difference in the fact that the operation timing at which an input device is operated by a player is determined and the moving direction of the movable object that is moving is changed, at least based on the determined operation timing.

In addition, the present invention is also directed to a program for a game apparatus that puts a computer into a running state. The program for a game apparatus of the present invention may cause the computer to execute a function of determining operation timing at which the input device is operated by a player, and a function of changing the moving direction of the movable object, at least based on the determined operation timing.

### BRIEF DESCRIPTION OF THE DRAWINGS

FIG. 1 illustrates one scene in which a game apparatus for a virtual or simulation game is used in an embodiment of the present invention as applied to such a game apparatus for a virtual or simulation game.

FIG. 2 is a perspective view of a body of the game apparatus used in this embodiment.

FIG. 3 is a cross-sectional view of the body of the game apparatus of FIG. 2, in which most of the internal mechanism is not illustrated.

FIG. 4 is a block diagram showing principal components of a circuit installed inside the body of the game apparatus of this embodiment.

FIG. 5 is a block diagram showing function-implementing means having various kinds of functions to be implemented inside a processor for games, and also illustrates the relationship of a light-emitting element a light-receiving element and a game tool.

FIG. 6 is a flowchart of an example algorithm used in implementing operation timing determination means in a computer.

FIG. 7 is a flowchart of an algorithm for f a program used when the present invention is applied to a game apparatus for a target-hitting game.

FIG. 8 illustrates an initial screen used with a game apparatus for a target-hitting game.

FIG. 9 illustrates an example of the display composition in an initial display mode used with the game apparatus for a target-hitting game.

FIG. 10 illustrates an example of the display composition in the second display mode.

FIG. 11 illustrates an example of the display composition in the third display mode.

FIG. 12 illustrates an example of the display composition in the fourth display mode.

FIG. 13 illustrates an example of the display composition in the fifth display mode.

FIG. 14 illustrates an example of the display composition in the sixth display mode.

### BEST MODE FOR CARRYING OUT THE INVENTION

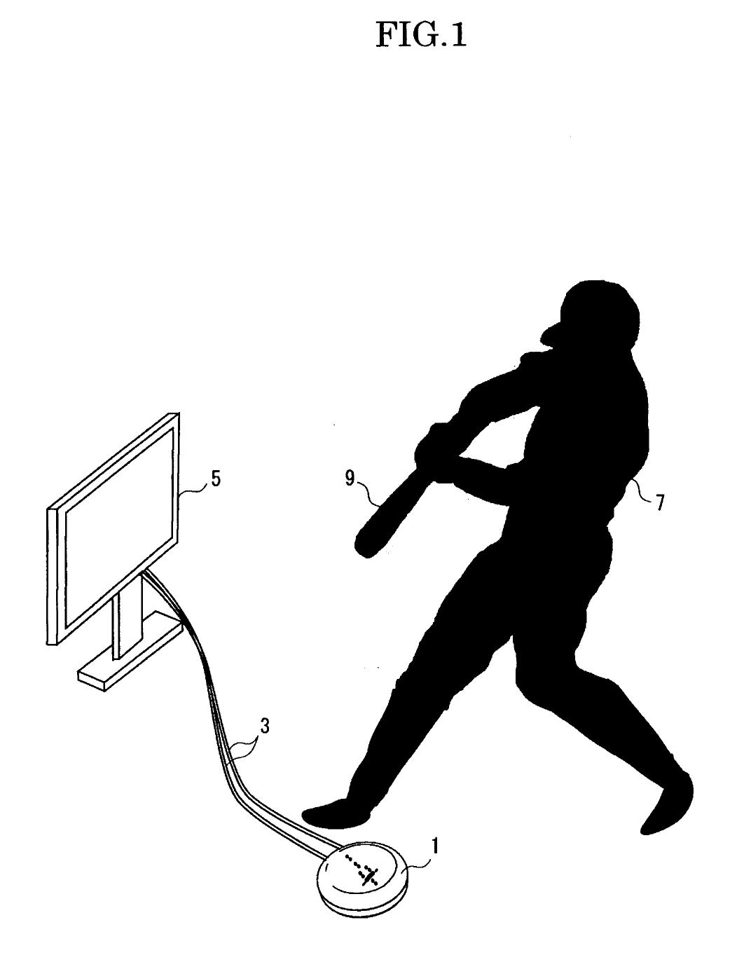

An embodiment of the present invention will now be described in detail with reference to the accompanying drawings. FIG. 1 illustrates one scene in which a game apparatus for a virtual or simulation game is used in an embodiment of the present invention as applied to a game apparatus for such a virtual or simulation game. In this figure, a body 1 of the game apparatus with switches thereof omitted from the illustration is connected directly to a television set 5 via a cord 3, and a game tool 9 that imitates a bat to be operated (swung) by a player 7 is used as a part of an input device.

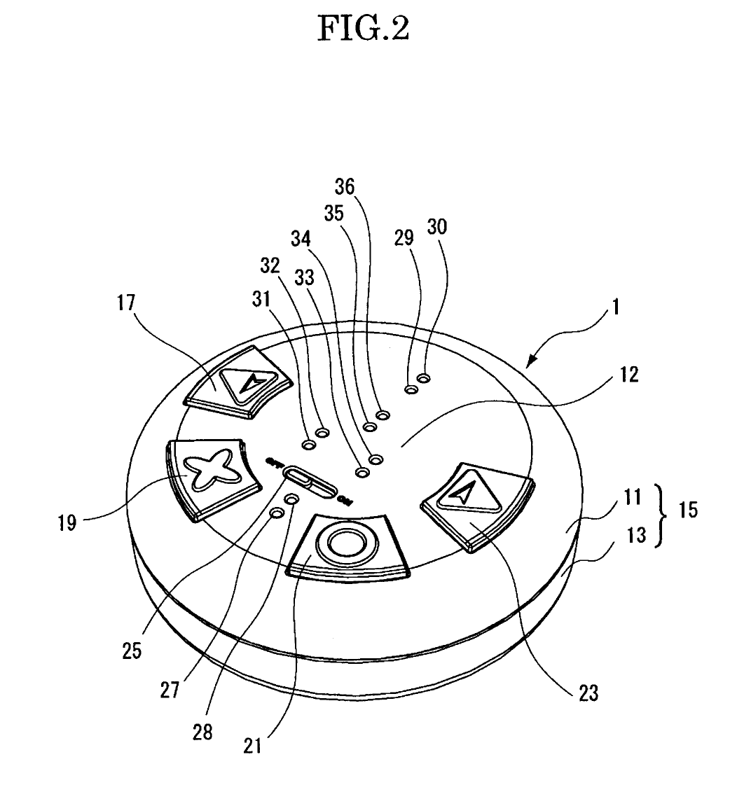

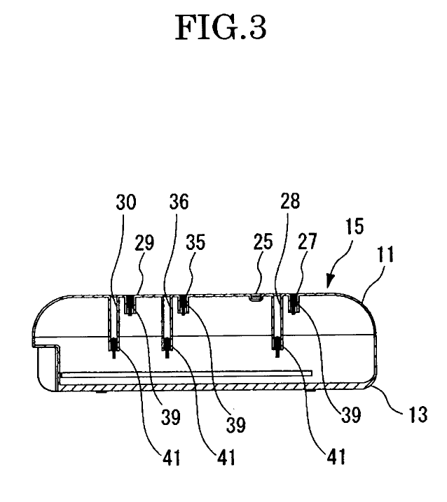

FIG. 2 is a perspective view of the body 1 of the game apparatus used in this embodiment. FIG. 3 is a cross-sectional view of the body 1 of the game apparatus, in which most of the internal mechanism is not illustrated. The body 1 of the game apparatus is provided with a casing 15 which is constituted by combining an upper half-portion 11 and a lower half-portion 13 that are formed by splitting the casing 15 into two up and down (in a vertical direction) Inside the casing 15 is disposed a circuit which includes a microcomputer as its principal component. On the surface of the upper half-portion 11 are arranged four pushbutton switches 17 to 23 (that is, 17, 19, 21 and 23) so that the switches can be pressed down. A sliding-type power switch 25 is disposed in an area 12 of the upper half-portion 11, which is surrounded by the four push button switches 17 to 23. These pushbutton switches 17 to 23 are operated when making an important selection in the course of the game, such as selection of the game type, pitcher, and repertoire of pitches. In the area 12 of the upper half-portion 11 are formed ten through-holes 27 to 36 which are paired up two by two. The through-holes 27 and 28, through-holes 29 and 30, through-holes 31 and 32, through-holes 33 and 34, and through-holes 35 and 36 are paired respectively. Light-emitting elements 39 are respectively disposed inside the through-holes 27, 29, 31, 33, and 35. Light-receiving elements 41 are respectively disposed inside the through-holes 28, 30, 32, 34, and 36. In this embodiment where the game apparatus is used for a simulated baseball game, only the light-emitting elements 39 disposed inside the through-holes 27, 28 and light-receiving elements 41 disposed inside the through-holes 29, 30 are actually used for detecting the motion (operation timing) of the game tool 9. As shown in FIG. 3, the light-receiving elements 41 are disposed lower than the light-emitting elements 39 (in the vicinity of the lower half-portion 13). In other words, the vertical length of each of the through-holes 28, 30, 32, 34, and 36 receiving the light-receiving elements 41 is longer than the vertical length of each of the through-holes 27, 29, 31, 33, and 35 receiving the light-emitting elements 39. In view of the light-emitting element 39, the shorter the distance of the light-emitting element 39 and the game tool 9 equipped with a light-reflecting material is, the more light will be reflected. In view of the light-receiving element 41, if the light-receiving element 41 is disposed too high (if the location thereof is of the same height as the light-emitting element 39 or higher than that), the light-receiving element 41 also receives the light other than the light emitted from the light-emitting element 39 and reflected by the game tool 9. Consequently, a signal outputted from the light-receiving element 41 includes much noise to cause an erroneous detection. A desirable distance in the vertical direction (up and down direction) between the light-receiving element 41 and the light-emitting element 39 is varied depending on various factors such as the height of a zone which is located above the body 1 of the game apparatus and through which the game tool 9 passes, a quantity of light emitted from the light-emitting element 39, an emission angle range of the light emitted from the light-emitting element 39 (an angular range where the light emitted from the light-emitting element 39 intersects the zone), a light-receiving angle range (an angular range in which light reflected from the game tool 9 through the through-holes 27, 29, 31, 33, and 35 can be received) of the light-receiving element 41 disposed on the bottom of each of the through-holes 28, 30, 32, 34, and 36, and a reflectance of the light reflecting material disposed on the game tool 9. Therefore, how long the above-mentioned distance should be is determined according to design factors.

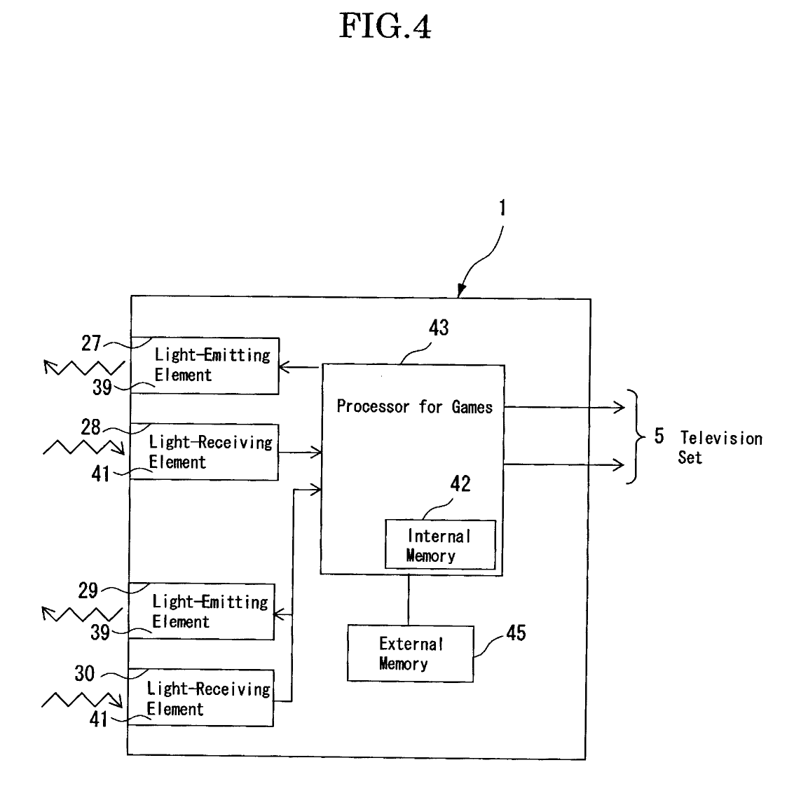

FIG. 4 is a functional block diagram showing principal components of a circuit installed inside the body 1 of the game apparatus according to this embodiment. Power circuits of the light-emitting elements 39 etc. are omitted from the illustration. What has been developed exclusively for a game apparatus can be applied as a processor 43 for games having an internal memory 42 which stores information acquired from a signal outputted from the light-receiving element 41. An example of such processor 43 for games (including a microcomputer) is shown in U.S. Pat. No. 3,467,382, and is publicly known. However, the processor for games used in carrying out the present invention is not limited to what is disclosed in the foregoing patent publication. A program necessary for running the processor 43 for games is stored in an external memory 45. Inside the processor 43 for games are also included circuits for processing a video signal and an audio signal. Therefore, an output from the processor 43 for games is outputted directly to a television set. It is needless to say that a circuit may be constructed without using such processor 43 for games.

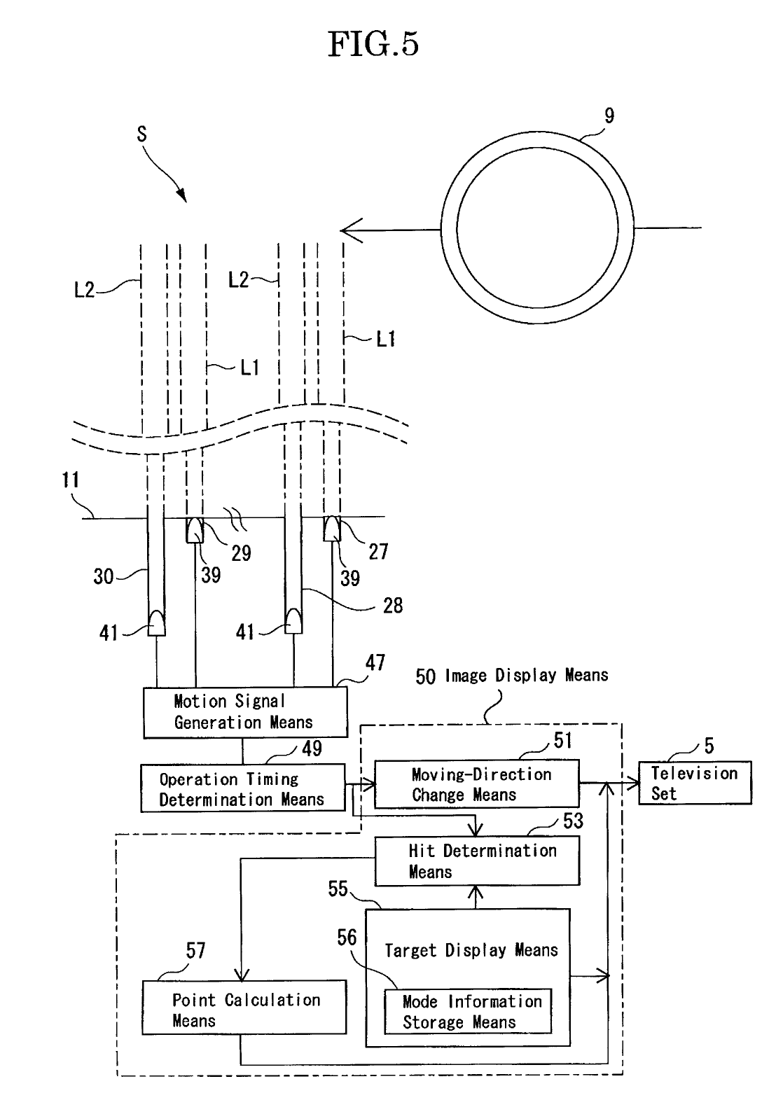

FIG. 5 is a block diagram showing function-implementing means having various kinds of functions to be implemented inside the processor 43 for games, and also illustrates the relationship of the light-emitting element 39, the light-receiving element 41, and the game tool 9. The function-implementing means shown in FIG. 5 includes motion signal generation means 47, operation timing determination means 49, image display means 50, moving-direction change means 51, hit determination means 53, target display means 55, mode information storage means 56 included in the target display means 55, and point calculation means 57. The image display means 50 has all the functions that the other means do not have and that are required for displaying images on the screen. The motion signal generation means 47 includes two light-emitting elements 39, 39 that emit out light L1 in a three dimensional space S in which the game tool 9 is operated, and two light-receiving elements 41, 41 which receive reflected light L2 emitted from the light-emitting elements 39 and reflected on the light reflecting material disposed on the surface of the game tool 9. In FIG. 5, for ease of understanding, the light L1 and the reflected light L2 are conveniently illustrated as beams parallel to each other. In this embodiment, one of the light-emitting elements 39 and one of the light-receiving elements 41 are used in pairs as previously explained. When the game tool 9 passes over the body 1 of the game apparatus, two light receiving signals are respectively outputted with time difference from the two light-receiving elements 41, 41. The motion signal generation means 47 generates a motion signal including information on the motion of the game tool 9 (information on the timing at which the game tool 9 was swung and the motion speed thereof) based on the two light receiving signals. The motion speed of the game tool 9 can be known by identifying a time interval between the generations of two light receiving signals. If the two light receiving signals are input after a predetermined time interval, or only one light receiving signal is input within a predetermined time interval, it can be determined that there has been a swing delay of the game tool 9. As well, the operation timing and motion speed as the game tool 9 is swung can be known from the generation time and generation interval of the two light receiving signals.

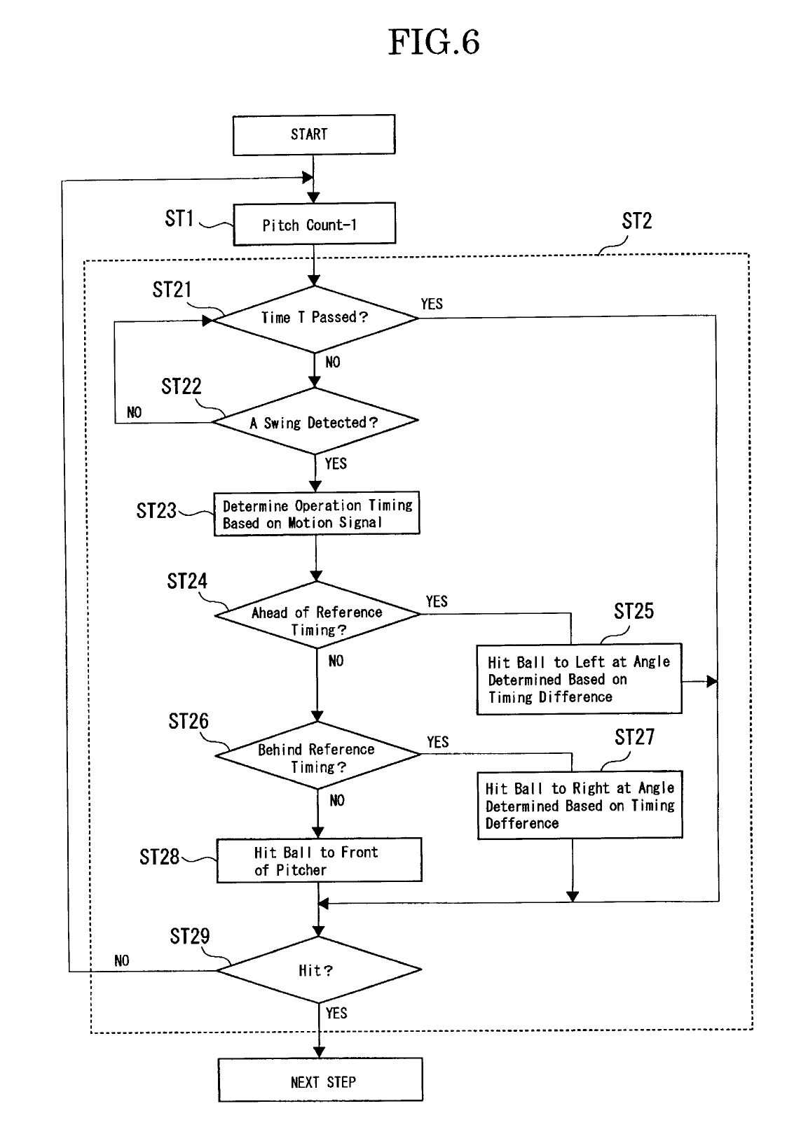

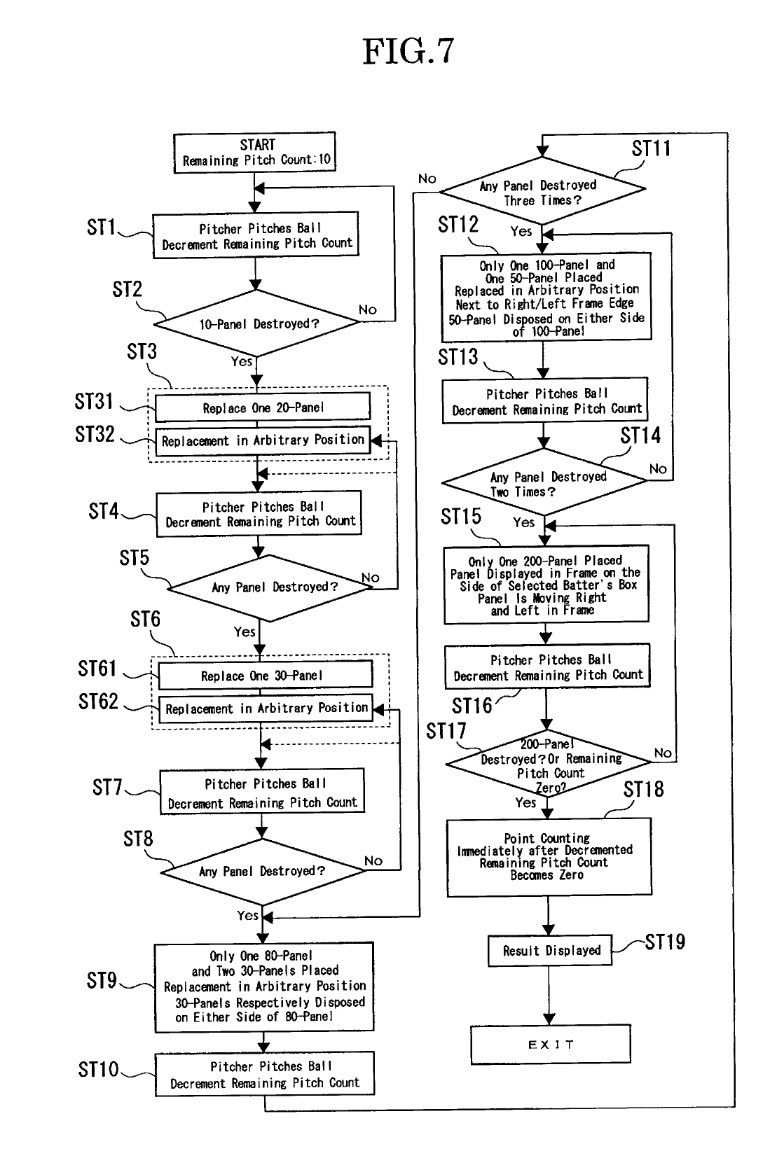

The operation timing determination means 49 determines timing at which the game tool 9 is swung based on the motion signal as the operation timing at which the input device is operated based on the motion signal and outputs a change command to the moving-direction change means 51 based on the operation timing. FIG. 6 is a flowchart of an example algorithm used in implementing the operation timing determination means 49 using a computer. The step ST2 in this example describes details of Steps ST1 and ST2 in the program used for an actual target-hitting game that will be explained later using FIG. 7. In this algorithm, the number of balls available for pitching (the number of remaining pitches) is decremented at the time that a pitcher has pitched a ball (movable object) in the course of the game and the operation timing is determined based on this time point (step ST2). The screen of the television set 5 displays a movement of the ball in such a manner the ball is approaching toward the player. After a predetermined time has passed since the pitcher pitched the ball (Step ST21) , when a swing is detected (step ST22) and a motion signal is outputted, the operation timing is determined based on the motion signal (step ST23). If the operation timing is ahead of predetermined reference timing, a change command to move (hit) the ball (movable object) leftward is outputted (step ST24, ST25). If the operation timing is behind the reference timing, a change command to move (hit) the ball rightward is outputted (step ST26, ST27). Otherwise, namely, when the reference timing and the operation timing coincide with each other, a change command to move (hit) the ball straight toward the pitcher is outputted (step ST28). Incidentally, an advance or delay of the operation timing from the reference timing determines the moving (flying) direction of the ball or an angle of the flying ball with respect to a home base (step ST25, ST27). These steps implement, using a computer, the operation timing determination means 49 shown in FIG. 5. In this example, it is determined at step 29 whether or not the ball hits at the target. The determination is made by the hit determination means 53 shown in FIG. 5. The movement of the ball is displayed on the screen by the moving-direction change means 51 shown in FIG. 5.

The moving-direction change means 51 outputs to the television set 5 a video signal that causes the ball (movable object) to be displayed on the screen as if it is moving (flying) from the pitcher toward the player after the pitcher has pitched the ball (movable object). Upon receipt of the above-mentioned change command from the operation timing determination means 49 during the movement of the ball, the moving-direction change means 51 outputs to the television set 5 a video signal by which the moving (flying) direction of the ball hit by the player is changed in accordance with the change command. A ball speed and repertoire of pitches (e.g. straight and curve) can also be changed according to a predetermined program as is publicly known. The hit determination means 53 determines whether or not the ball (movable object) has hit at the target based on the command signal obtained from the operation timing determination means 49 and positional information on the targets obtained from the target display means 55.

The target display means 55 shown in FIG. 5 has a function of displaying one or more targets to be hit with the ball (movable object) on the screen. The target display means 55 has a function of displaying the one or more targets on the screen in accordance with one display mode selected from a plurality of the display modes having a different mode change condition and a different display composition respectively, and a function of selecting another display mode from the plurality of display modes when the mode change condition of the selected display mode has been satisfied. Then, the target display means 55 includes built-in mode information storage means for storing the information about the plurality of display modes respectively having a mode change condition and a display composition. This embodiment is provided with point calculation means 57 for calculating the point based on determination results made by the hit determination means 53. How to calculate points by the point calculation means 57 can be defined arbitrarily.

Here, the mode change condition means a necessary condition to change the display mode to be used in the game by arbitrarily selecting one display mode from the plurality of display modes. For example, it may include the number of times that the ball has hit at the targets, the points scored by hitting the ball at the targets, and hitting the ball at one or more particular targets. The display composition of the display mode includes diversified display patterns formed by diversified combinations of the number of targets, target shapes, points indicated on the face of each of the targets, target locations, and whether or not the targets are moving, which are displayed on the screen until one mode change condition is satisfied. Therefore, when the display mode is changed, the points indicated on the targets, target locations and others are accordingly changed. It is arbitrary how to define the display composition of one display mode.

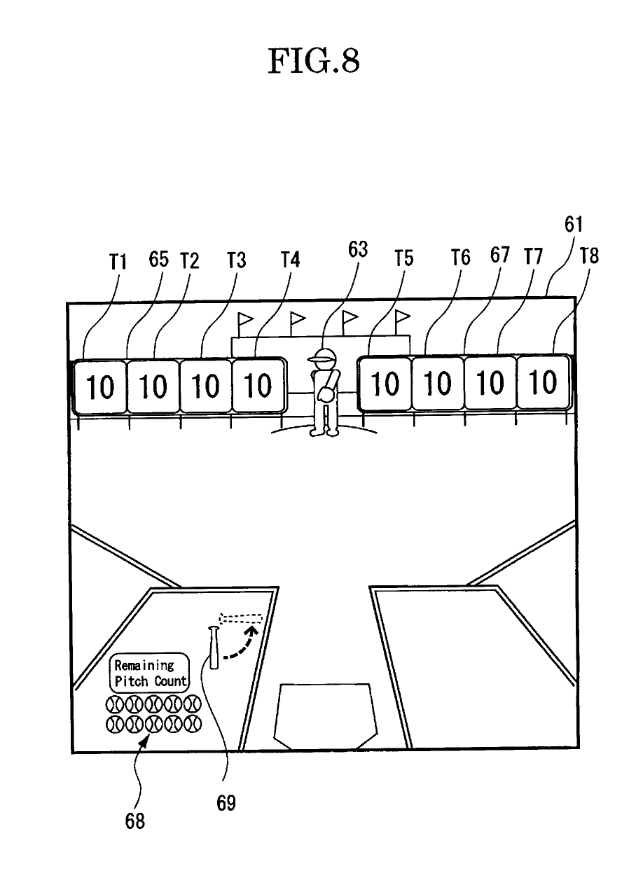

FIG. 7 is a flowchart of an algorithm of a program used when the present invention is applied to a game apparatus for a target-hitting game. FIG. 8 illustrates an initial screen used with this game apparatus for a target-hitting game. On a screen 61 of FIG. 8, eight target panels T1 to T8 are arranged side by side in the play field or mound, four by four on both sides of the pitcher 63. In the play field are respectively displayed target holding frame 65 which holds the four target panels T1 to T4 and a target holding frame 67 which holds the other four target panels T5-T8. The plurality of targets T1 to T8 are displayed on the screen 61 based on the video signal from the target display means 55 shown in FIG. 5.

Ball images 68, the number of which corresponds to the number of pitcher's remaining pitches, are displayed in the lower left area of a batter's box on the left side of the screen 61. Since FIG. 8 is the initial screen, ten balls images are displayed as the number of the pitcher's remaining pitches. As well, a bat image 69, which is a simulated image of the game tool 9, is displayed in the upper right area of the batter's box on the left side of the screen 61. The bat image 69 moves to a position indicated with a broken line to denote that the game tool 9 has been operated properly by the player, when the motion determination means, not shown, which is provided in the image display means 50 determines that the game tool 9 has been operated properly (the game tool 9 has passed through a predetermined zone above the body 1 of the game apparatus, or a motion signal has been outputted). It can be known from this indication whether or not the position, where the player has swung the game tool 9, which is a part of the input device, falls within a detection area of a swing detector constituted by the light-emitting elements 39 and the light-receiving elements 41 as shown in FIGS. 3 to 5. Therefore, if the bat image does not move even though the player has swung the game tool 9 within a predetermined time after the pitcher 63 pitched the ball, the player can then know that the swing position of the game tool 9 is not proper. With this indication, the player changes the position of the body 1 of the game apparatus or the standing position of the player.

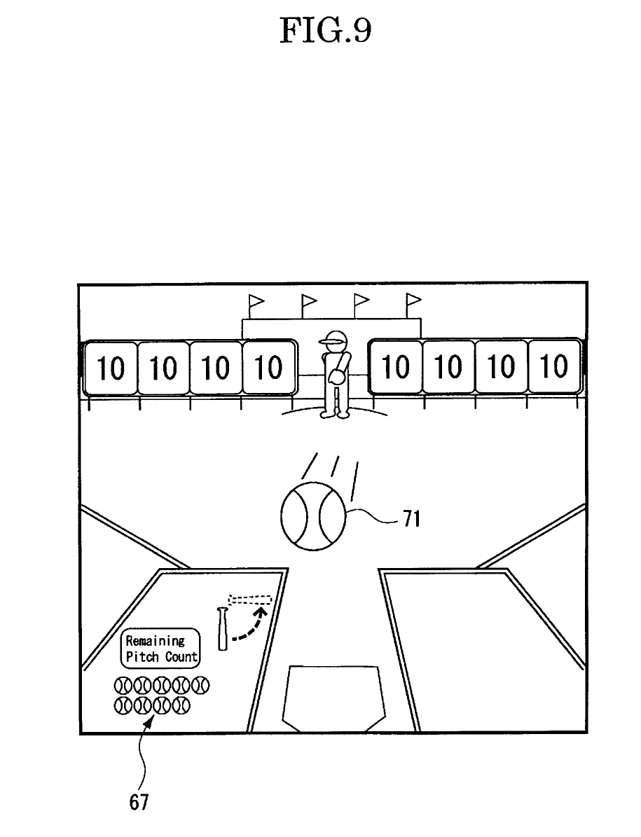

Now, the course of the game will be described according to the algorithm shown in FIG. 7. First, an initial display mode is selected and a display composition of the selected display mode is displayed on the screen 61. When a first pitch is thrown, the screen 61 shows an animated image of a ball 71 moving toward the player as shown in FIG. 9. Then, he number of the remaining pitches is decremented to 9 (there are nine ball images 68 displayed). In the step ST2, as explained in the above-mentioned FIG. 6, the operation timing at which the player has swung the game tool 9 is determined. Then a flying direction (flying angle) of the ball 71 is determined in accordance with a change command outputted by the determined operation timing. The moving-direction change means 51 shown in FIG. 5 moves the ball 71 on the screen 61 so that the ball 71 may fly toward a determined direction. Then, the hit determination means 53 shown in FIG. 5 determines whether or not the ball 71 has hit at any of the targets T1 to T8, and which of the targets has been hit. In a state shown in FIG. 9, the numeral “10” is indicated on the faces of all the targets T1 to T8. These numerals serve as criteria in calculating points obtained when the ball hits at a target. In the following descriptions, the targets with numerals of 10, 20, 30, 50, 80, 100, and 200 indicated thereon are respectively called 10-panel, 20-panel, 30-panel, 50-panel, 80-panel, 100-panel, and 200-panel. In the step ST2, it is finally determined whether or not one of the eight 10-panels has been destroyed by the ball 71 (namely, whether or not the ball 71 has hit at a 10-panel) If the ball 71 does not hit at any of the 10-panels, the game process returns to step ST1 and a next pitching is performed. The steps 1 and 2 are repeated until one 10-panet has been destroyed, and the number of the remaining pitches is decremented. This condition is a mode change condition in the initial display mode. Although not shown in the step ST2 of FIG. 7, it is also determined in the step ST2 whether or not the number of the remaining pitches becomes zero. When the number of the remaining pitches becomes zero, the game process skips to step ST18 that will be described later wherein score counting is performed.

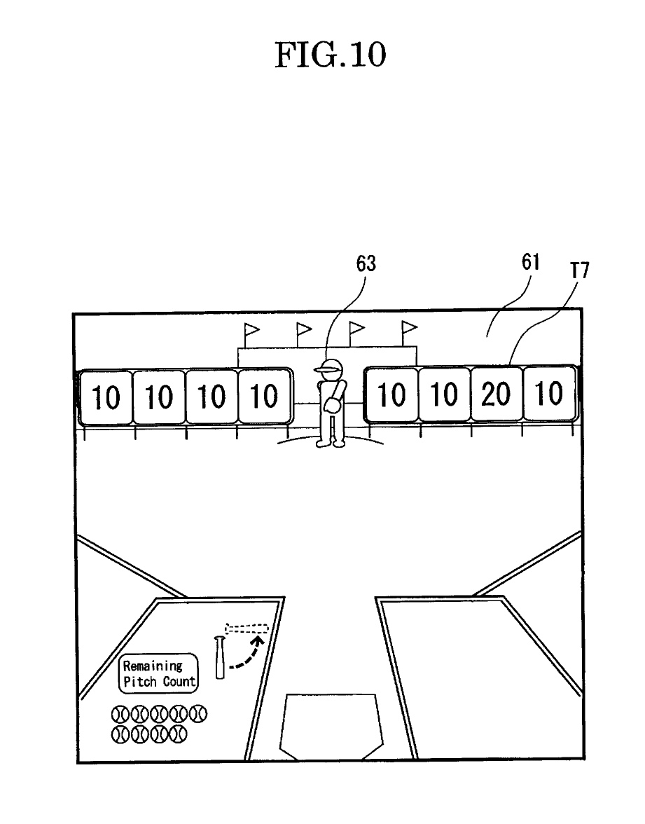

If the mode change condition for the initial display mode is satisfied, a second display mode is then selected to change a display composition to be displayed on the screen. When the game process proceeds from step ST2 to step ST3, both steps ST31 and ST32 constituting step 3 are simultaneously carried out (namely, step ST31 and step ST32 are not carried out in this order) , then one of the 10-panel targets is replaced arbitrarily with a 20-panel. FIG. 10 shows a display composition displayed on the screen 61 for the player's second batting against the pitcher's second pitching according to the second display mode after one 10-panel was destroyed. In the subsequent course of the game, step ST32 for panel replacement is executed until the ball hits at any one of the targets. Therefore, the display position of the 20-panel is varied each time. Actually, the target destroyed by the ball 71 is not replaced, but an arbitrary target is replaced from a 10-panel to a 20-panel.

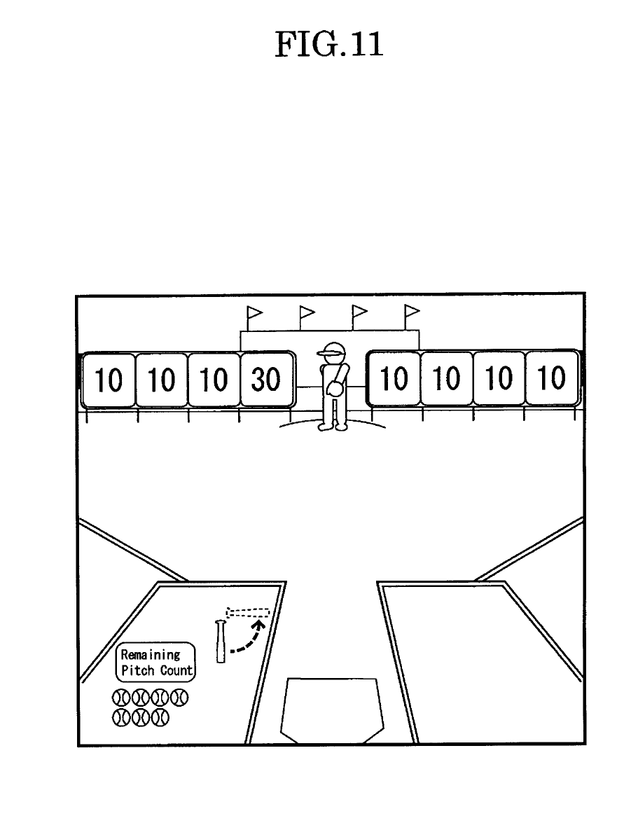

Next, the process goes to step ST4. In the step ST4, as with step ST1, the pitcher's pitching and the number of remaining pitches which is decremented are displayed on the screen. In step ST5, as with step ST2, the operation timing, the direction of the batted ball, and whether or not the ball has hit at a target are determined to know if any panel (target) has been destroyed. The process from step ST32 to the step ST5 is repeated until the ball hits at a panel (target). Therefore, while the ball continues to fail to hit at any panel, the display position of the 20-panel is varied arbitrarily on the screen. Alternatively, the process may return to step ST4 from step ST5 without returning to step ST3 as is indicated with a broken line. In this case, the position of the 20-panel does not change. If it is determined that any one of the panels has been destroyed in step ST5, the process goes to step ST6 and one panel is replaced by a 30-panel. The step ST6 consists of step ST61 for replacing one panel by a 30-panel and step ST62 for deciding a replacement position of the panel arbitrarily. As with step ST3, since steps ST61 and ST62 are simultaneously carried out when the process goes to step ST6 from step ST5, one arbitrary panel is replaced by the 30-panel. In the subsequent course of the game, step ST62 is executed. When “NO” is determined in step ST8 as explained later, the process returns to step ST62 and a 30-panel is replaced as if it is changing its position on the screen. The above-mentioned condition is a mode change condition in the second display mode. The condition in step ST5 is the mode change condition in the second display mode. Although not shown in step ST5 of FIG. 7, it is also determined in the step ST5 whether or not the number of the remaining pitches becomes zero. When the number of the remaining pitches becomes zero, the game process skips to step ST18 that will be mentioned later wherein score counting is performed. In step ST6, the second display mode is changed to the third display mode. FIG. 11 shows an example of a display composition according to the third display mode.

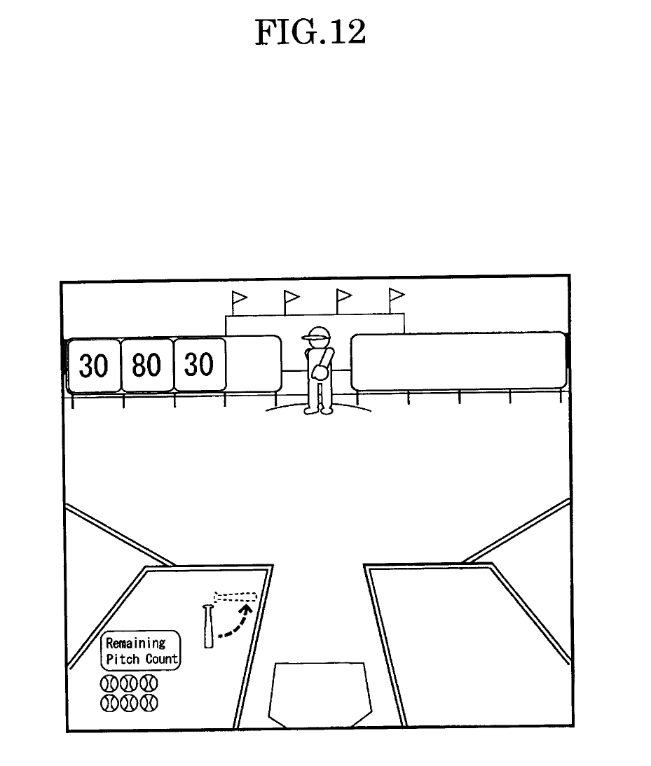

In step ST7, as with step ST1, the pitcher's pitching and the number of the remaining pitches which is decremented are displayed on the screen. In step ST8, as with step ST2, the operation timing, the direction of a batted ball, and whether or not the ball has hit at a target are determined know if any panel (target) has been destroyed. The process from step ST62 to step ST8 is repeated until the ball hits at a panel (target). Therefore, while the ball continues to fail to hit at any panel, the display position of the 30-panel is varied arbitrarily on the screen and it sees that the 30-panel is moving. Incidentally, the process may return to step ST7 from step ST8 without returning to step ST62 as indicated with a broken line. In this case, the position of the 30-panel does not change. The determination in step ST8 is a mode change condition in the third display mode. When it is determined in the step ST8 that any one of the panels has been destroyed, the process goes to step ST9, and the number of the target panels is decreased from eight to three, one 80-panel and two 30-panels. Although the positions of these three panels are arbitrary, it is defined in this example that the 30-panels are always disposed respectively on either side of the 80-panel. In step ST9, the third display mode is changed to the fourth display mode. Although not shown in step ST8 of FIG. 7, it is also determined in step ST8 whether or not the number of remaining pitches becomes zero. When the number of remaining pitches becomes zero, the game process skips to step ST18 that will be mentioned later wherein score counting is performed. FIG. 12 illustrates an example screen 61 of the display composition in the fourth display mode.

The process then goes to step ST10, in which the pitcher's pitching and the number of remaining pitches that is decremented are displayed, as with step ST1. In step ST11, as with step ST2, the operation timing, the direction of the batted ball, and whether or not the ball has hit at a target are determined to know if any panel (target) has been destroyed. The process from step ST9 to step ST11 is repeated until the ball hits at any of the panels (targets) three times (any of the three panels is destroyed and the total destroyed panels becomes three). In step ST9, three panels are restored each time that one panel is destroyed. In step ST11, when it is determined that three panels in total have been destroyed, the process goes to step ST12 in which the number of targets is decreased from three to two, one 100-panel and one 50-panel. Step ST11 is the mode change condition in the fourth display mode. In step ST12, another display mode is selected as the fifth display mode and the fourth display mode is changed to the fifth display mode. Although not shown in step ST11 of FIG. 7, it is also determined in the step ST11 whether or not the number of remaining pitches becomes zero. When the number of remaining pitches becomes zero, the game process skips to step ST18 which will be mentioned later wherein score counting is performed.

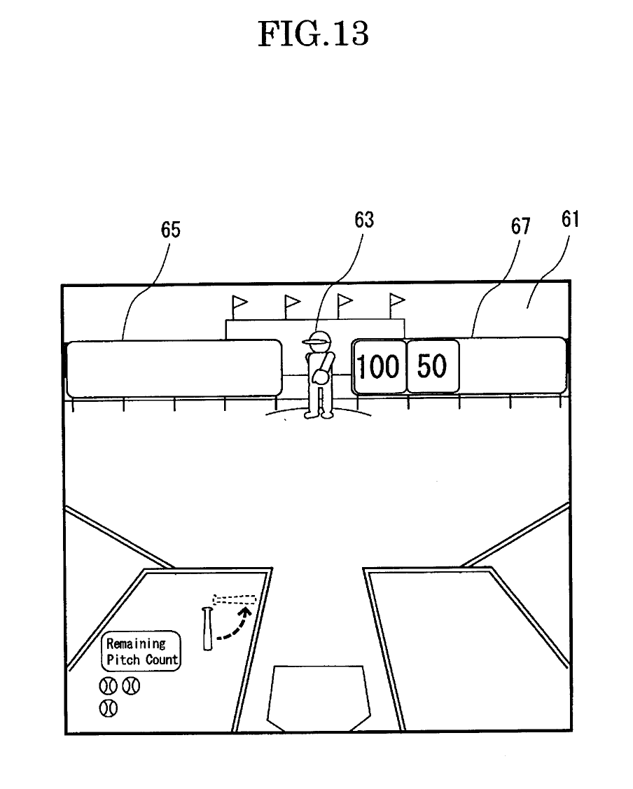

FIG. 13 illustrates an example screen 61 of the display composition of the fifth display mode. In this display mode, as shown in FIG. 13, two panels are held side by side in either of the right and left target holding frames 65 or 67, and one of the two panels is located to be in contact with the edge of the target holding frame. In a state shown in FIG. 13, the 100-panel is in contact with the left-side edge of the target holding frame 67 on the screen.

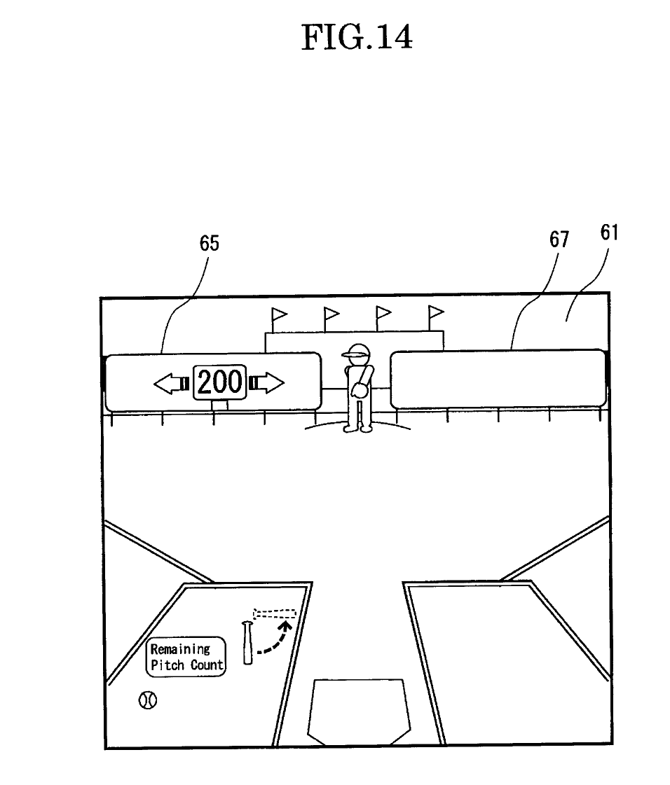

The process then goes to step ST13, as with step ST1, in which the pitcher's pitching and the number of remaining pitches are displayed. In step ST14, as with step ST2, the operation timing, the direction of the batted ball, and whether or not the ball has hit at a target are determined to know if any panel (target) has been destroyed. The process from step ST12 to step ST14 is repeated until the ball hits at a panel (target) two times (until either of the two panels is destroyed and the total number of destroyed panels becomes two). In step ST12, two panels are restored each time one panel is destroyed. When it is determined in step ST14 that two panels in total have been destroyed, the process goes to step ST15 in which the target becomes only one 200-panel. The step ST14 is the mode change condition in the fifth display mode. In step ST14, another display mode is selected as the sixth display mode and the fifth display mode is changed to the sixth display mode. Although not shown in step ST14 of FIG. 7, it is also determined in step ST14 whether or not the number of remaining pitches becomes zero. When the number of remaining pitches becomes zero, the game process skips to step ST18 that will be mentioned later wherein score counting is performed. FIG. 14 illustrates an example screen 61 of the display composition of the sixth display mode. In this display mode as shown in FIG. 14, a 200-panel is displayed in the target holding frame 65, which is one of the right and left target holding frames 65 and 67 corresponding to the batter's box the player has selected in advance (the batter's box on the left side of the screen in this case). The displayed 200-panel is moving right and left within the target holding frame 65. In the sixth display mode, since the 200-panel is moving, it is very difficult to hit the ball at the target. The process goes to step ST16, in which the pitcher's pitching and the number of remaining pitches that is decremented are displayed. In step ST17, as with step ST2, the operation timing, the direction of the batted ball, and whether or not the ball has hit at a target are determined to know if the 200-panel (target) has been destroyed. What is more, it is also determined whether of not the number of remaining pitches becomes zero. The process from step ST15 to step ST17 is repeated until the ball hits at the 200-panel (target) or the number of remaining pitches becomes zero.

When the ball hits at the 200-panel (target) or the number of remaining pitches becomes zero in step ST17, score counting is executed in step ST18. Then a result is displayed on the screen in step ST19. How to execute the score counting is arbitrary. A simple example of score counting may be totalizing the numeric values indicated on the respective destroyed panels. However, it is also possible to convert the ball speed and the kind of the ball pitched by the pitcher into a coefficient and then to multiply the numeric value indicated on the destroyed panel by this coefficient, and finally to totalize the calculated values as score counting.

In the foregoing embodiment, though the game tool 9 and the body 1 of the game apparatus operated by the player are used as an input device, it is needless to say that the present invention can also be applied to a game apparatus which employs as an input device a pushbutton-operated game controller mounted on the body 1 of the game apparatus without using the game tool. In this case, timing at which the pushbutton is pressed (operated) is determined as the operation timing.

In the foregoing embodiment, as well, although whether or not the game tool 9 is operated is determined using reflection of light, it is needless to say that various kinds of sensors such as an acceleration sensor can be used for determination of whether or not the game tool 9 is operated.

In the foregoing embodiment, although the present invention is applied to a baseball game, it is needless to say that the present invention can be applied to any games as far as the games are played by hitting a moving movable object with a game tool, such as tennis, badminton, table tennis, and hockey.

### INDUSTRIAL APPLICABILITY

According to the present invention, the player's interest in the game can be increased, and an unprecedented game apparatus for a target-hitting game can be provided.

1. A game apparatus for playing a game that allows a player to operate an input device in such a manner that a moving direction of a movable object, which is displayed by image display means on a screen and is moving on the screen, is changed based on an input from the input device operated by the player in order to hit the movable object at a target displayed on the screen, the game apparatus comprising:
target display means for displaying on the screen one or more targets to be hit with the movable object,
operation timing determination means for determining operation timing at which the input device is operated by the player, and
moving-direction change means for moving the movable object and changing the moving direction of the movable object according to a change command upon receipt of the change command while moving the movable object,
wherein the operation timing determination means outputs the change command to the moving-direction change means based on the determined operation timing.

2. The game apparatus according to claim 1, further comprising hit determination means for determining whether or not the movable object has hit at the one or more targets,
wherein the target display means has a function of displaying the one or more targets on the screen in accordance with one display mode selected from a plurality of display modes having a different mode change condition and a different display composition and also has a function of selecting another display mode from the plurality of display modes when it is determined by the hit determination means that the mode change condition of the selected display mode has been satisfied.

3. The game apparatus according to claim 2, wherein the target display means selects the display mode from the plurality of display modes in a predetermined order, or at random, or in accordance with a predetermined select condition.

4. The game apparatus according to claim 3, wherein the display compositions of the plurality of display modes are defined so that the number of the one or more targets to be displayed on the screen may decrease as the display mode is selected later.

5. The game apparatus according to claim 2, wherein the mode change conditions of the plurality of display modes are defined to become more complex as the display mode is selected later.

6. The game apparatus according to claim 2, wherein at least one of the plurality of display modes is defined to move the one or more targets.

7. The game apparatus according to claim 1, wherein
the input device includes a game tool to be operated by the player in a three dimensional space, and motion signal generation means for detecting a motion of the game tool in the three dimensional space and outputting a motion signal according to the detected motion; and
the operation timing determination means determines the operation timing based on timing at which the motion signal is generated.

8. The game apparatus according to claim 7, wherein the game tool is a simulated-sports game tool that imitates sports equipment such as a bat and a racket, or a wearable game tool that is a substitution for a shoe for the player's foot and for a hand of the player.

9. The game apparatus according to claim 7, wherein
the motion signal generation means is received in a body of the game apparatus;
the game tool has on its surface a light-reflecting material that reflects light;
the motion signal generation means includes a light-emitting element that emits out light in the three dimensional space in which the game tool is operated and a light-receiving element that receives reflected light that has been emitted from the light-emitting element and reflected on the light-reflecting material; and
the motion signal is generated based on an output from the light-receiving element.

10. A game apparatus for playing a game that allows a player to operate an input device in such a manner that a moving direction of a movable object, which is displayed by image display means on a screen and is moving on the screen, is changed based on an input from the input device operated by the player in order to hit the movable object at a target displayed on the screen,
wherein the moving direction of the movable object is changed based on operation timing at which the input device is operated.

11. A moving-direction determination method for a movable object in a game apparatus for playing a game in which a moving direction of the movable object displayed on a screen is determined to hit the movable object at one or more targets displayed on the screen, comprising the steps of:
determining operation timing at which an input device is operated by a player; and
changing the moving direction of the movable object that is moving, at least based on the determined operation timing.

12. A program for a game apparatus that causes a computer to determine a moving direction of a movable object in a computer game in which the moving direction of the movable object displayed on a screen is determined in order to hit the movable object at one or more targets displayed on the screen, the program causing the computer to execute:
a function of determining operation timing at which the input device is operated by a player, and
a function of changing the moving direction of the movable object that is moving, at least based on the determined operation timing.

13. A recording medium recorded with the program for a game apparatus of claim 12.
